(19) United States
(12) Patent Application Publication
(10) Pub. No.: US 2026/0328340 A1
(43) Pub. Date: Oct. 22, 2026

(54) RADIATION HAZARD PROTECTION SYSTEM

(71) Applicant: BAE Systems Information and Electronic Systems Integration Inc., Nashua, NH (US)

(72) Inventor: Peter Dusaitis, Manchester, NH (US)

(73) Assignee: BAE Systems Information and Electronic Systems Integration Inc., Nashua, NH (US)

(21) Appl. No.: 19/087,887

(22) Filed: Mar. 24, 2025

(51) Int. Cl. F16P 3/14; B64F 5/40; G01S 7/481; G01S 17/04

(52) U.S. Cl. CPC F16P 3/147; B64F 5/40; G01S 7/4817; G01S 17/04

(57) ABSTRACT

Techniques for radiation hazard protection. A system according to an example includes a light detection and ranging (lidar) transmitter configured to transmit a lidar signal over a scan area and a lidar receiver configured to receive reflections of the transmitted lidar signal from one or more objects within the scan area. The system also includes a pixel processor configured to generate an array of pixels, each of the pixels mapped to one of the received reflections. The pixels provide a range from the lidar transmitter to a point on one of the one or more objects. The system further includes a hazard detector configured to determine that at least one of the one or more objects is located within the scan area based on an analysis of the array of pixels. The system further includes a radiation transmission controller configured to disable a radiation transmitter based on the determination.

### FIELD OF DISCLOSURE

The present disclosure relates to safety systems, and more particularly to a radiation hazard protection system.

### BACKGROUND

Aircraft, and particularly military aircraft (including helicopters and unmanned aerial vehicles), may employ high power radio frequency (RF) transmitters and/or laser transmitters. These transmitters are typically intended to be used during flight, for example during a mission, but it is possible that they can be activated, perhaps unintentionally, while the aircraft is on the ground, or otherwise at a time when the transmitted energy may cause unintended harm. In such case, the emitted radiation, whether RF or laser, can pose a serious hazard to personnel (e.g., crew, technicians, maintenance people) that happen to be in proximity of the aircraft.

### BRIEF DESCRIPTION OF THE DRAWINGS

FIG. 1 illustrates a radiation hazard protection scenario, in accordance with certain embodiments of the present disclosure.

FIG. 2 illustrates operation of the radiation hazard protection system of FIG. 1, configured in accordance with certain embodiments of the present disclosure.

FIG. 3 is a block diagram of the radiation hazard protection system of FIGS. 1 and 2, configured in accordance with certain embodiments of the present disclosure.

FIG. 4 illustrates a lidar scan pixel array, in accordance with certain embodiments of the present disclosure.

FIG. 5 is a flowchart illustrating a methodology for providing radiation hazard protection, in accordance with an embodiment of the present disclosure.

FIG. 6 is a block diagram of a processing platform configured to provide radiation hazard protection, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for protection of personnel from radiation hazards associated with RF or laser transmissions from, for example, an aircraft or a ground-based platform. As noted above, aircraft, and particularly military aircraft (including helicopters and unmanned aerial vehicles), may employ high power RF transmitters and/or laser transmitters. These transmitters are typically intended to be used during flight, for example during a mission, but it is possible that they can be activated, perhaps unintentionally, while the aircraft is on the ground or at lower altitudes. Certain ground-based platforms may be configured with similar transmitters and pose a similar risk. In any such cases, the emitted radiation, whether RF or laser, can pose a serious hazard to personnel (e.g., crew, technicians, maintenance people) that happen to be in proximity of the emitting aircraft or other platform.

To this end, and in accordance with an embodiment of the present disclosure, a radiation hazard protection system is described. The system employs a light detection and ranging (lidar) system to scan a volumetric region, referred to as a radiation hazard zone, within which a person or equipment could be harmed by RF or laser radiation emitted by transmitters on the aircraft. Upon detection on an object within the hazard zone, the system disables the aircraft transmitters rapidly enough to prevent or mitigate potential harm to any person or equipment in that zone. For example, maintenance personnel could be working near or under an aircraft and the radiation hazard protection system can prevent the RF transmitter or laser system of the aircraft from being accidentally activated. In another example scenario, the aircraft RF transmitter or laser system may be in an active transmitting state for some intentional purpose, such as testing, when a person accidentally enters the hazard zone. In this case the radiation hazard protection system can detect the presence of the person and shut down the transmitters.

In accordance with an embodiment, a system implementing the techniques for radiation hazard protection includes a lidar transmitter configured to transmit a lidar signal over a scan area and a lidar receiver configured to receive reflections of the transmitted lidar signal from one or more objects within the scan area. The system also includes a pixel processor configured to generate an array of pixels, each of the pixels mapped to one of the received reflections. The pixels provide a range from the lidar transmitter to a point on one of the one or more objects. The system further includes a hazard detector configured to determine that at least one of the one or more objects is located within the scan area based on an analysis of the array of pixels. The system further includes a radiation transmission controller configured to disable a radiation transmitter based on the determination.

It will be appreciated that the techniques described herein may provide improved radiation hazard protection, compared to other methods such as cordoning off an area or employing manual lockouts, which may be impractical or accidentally overlooked. Numerous embodiments and applications will be apparent in light of this disclosure.

### System Architecture

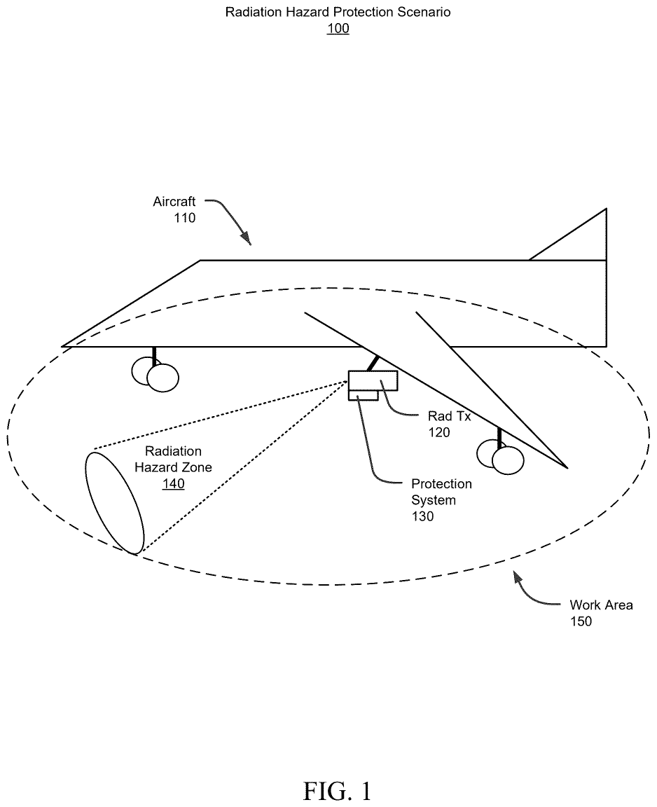

FIG. 1 illustrates a radiation hazard protection scenario 100, in accordance with certain embodiments of the present disclosure. An aircraft 110 is shown to include a radiation transmitter 120 which may be configured to transmit relatively high power RF signals and/or laser signals (e.g., at power levels that can be dangerous). The radiation transmitter 120 may be located anywhere on the aircraft 110 including, for example, under the fuselage or under the wings. A radiation hazard zone 140 is also shown which may be a cone shaped volume in which any transmissions from the radiation transmitter 120 are powerful enough to pose a hazard to personnel in that zone. The radiation hazard zone 140 may encompass a relatively large volume of space that extends out to a safe distance.

A radiation hazard protection system 130 is shown to be located adjacent to or near the radiation transmitter 120 which enables a lidar transmitter of the protection system 130 to scan the hazard zone 140. In some embodiments, the radiation hazard protection system 130 may be located at other suitable locations on the aircraft if those locations provide a field of view that overlaps with the radiation hazard zone 140.

A work area 150 is also shown in which the presence of humans may be expected. Overlap between the radiation hazard zone 140 and the work area 150 causes the potential for harm to personnel which can be mitigated by the radiation hazard protection system 130.

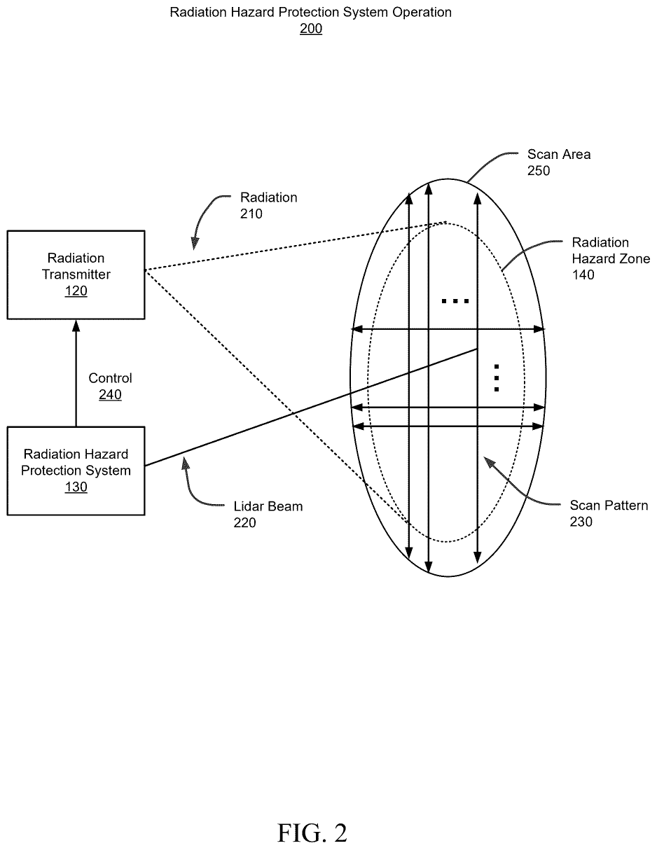

FIG. 2 illustrates operation 200 of the radiation hazard protection system 130 of FIG. 1, configured in accordance with certain embodiments of the present disclosure. The radiation transmitter 120 of the aircraft is shown to emit radiation 210 (e.g., RF or laser radiation) over a volumetric radiation hazard zone 140. The radiation hazard protection system 130 transmits a lidar beam 220 using a scan pattern 230 that covers a scan area 250 which substantially overlaps or exceeds the angular boundaries of the radiation hazard zone 140 at a maximum desired range (e.g., the range at which the radiation poses a hazard). In this example, the scan pattern 230 is shown as a series of vertical and horizontal scans, but any suitable scan pattern may be used which covers the hazard zone, including circular patterns, and the like. The range of the lidar beam 220 is great enough to provide protection not just near the radiation transmitter 120, but over a hazard zone 140 of relatively large volume.

The radiation hazard protection system analyzes reflections of the lidar beam, as described below, to determine if an object (or in some embodiments, a human) is present within the hazard zone 140. If an object is detected within the hazard zone, a control signal 240 is sent to the radiation transmitter 120 to lock out the transmitter (e.g., to cause the transmitter to cease transmitting the RF or laser radiation 210).

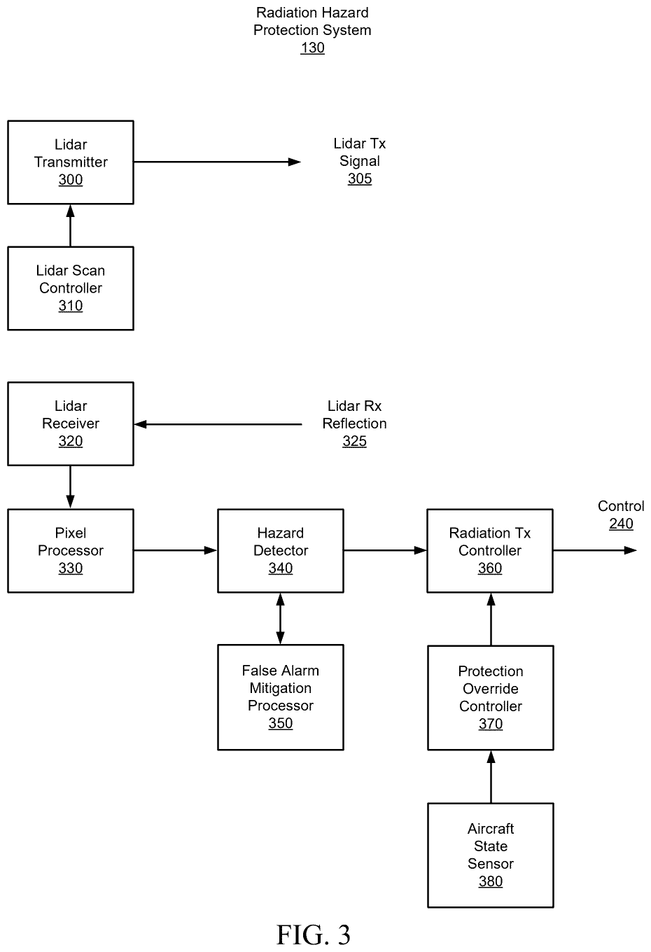

FIG. 3 is a block diagram of the radiation hazard protection system 130 of FIGS. 1 and 2, configured in accordance with certain embodiments of the present disclosure. The radiation hazard protection system is shown to include a lidar transmitter 300, a lidar scan controller 310, a lidar receiver 320, a pixel/point cloud processor 330, a hazard detector 340, a false alarm mitigation processor 350, a radiation transmitter controller 360, a protection override controller 370, and an aircraft state sensor 380.

The lidar transmitter 300 is configured to transmit and sweep a lidar beam 220 over a scan area 250 that overlaps with the radiation hazard zone 140. In some embodiments, the lidar beam is a pulsed signal 305 wherein each pulse is directed in an incrementally different direction as the lidar beam scans through the scan area.

The lidar scan controller 310 is configured to select the scan area 250 based on a volumetric region (e.g., the radiation hazard zone 140) over which radiation 210 propagates from the radiation transmitter 120 of the aircraft 110. The lidar scan controller 310 is also configured to control the sweeping of the lidar transmitter 300 over the scan area 250. In some embodiments, the radiation 210 is a laser beam or an RF transmission.

The lidar receiver 320 is configured to receive reflections 325 of the transmitted lidar beam 220 from one or more objects within the scan area. In some embodiments, each reflection is associated with one of the pulses of the transmitted pulsed signal 305.

The pixel/point cloud processor 330 is configured to generate an array of pixels. Each of the pixels is mapped to one of the received reflections and provides a range from the lidar transmitter to a point on one of the one or more objects. The range may be determined by timing the round trip of the reflected pulse from the lidar transmitter back to the lidar receiver.

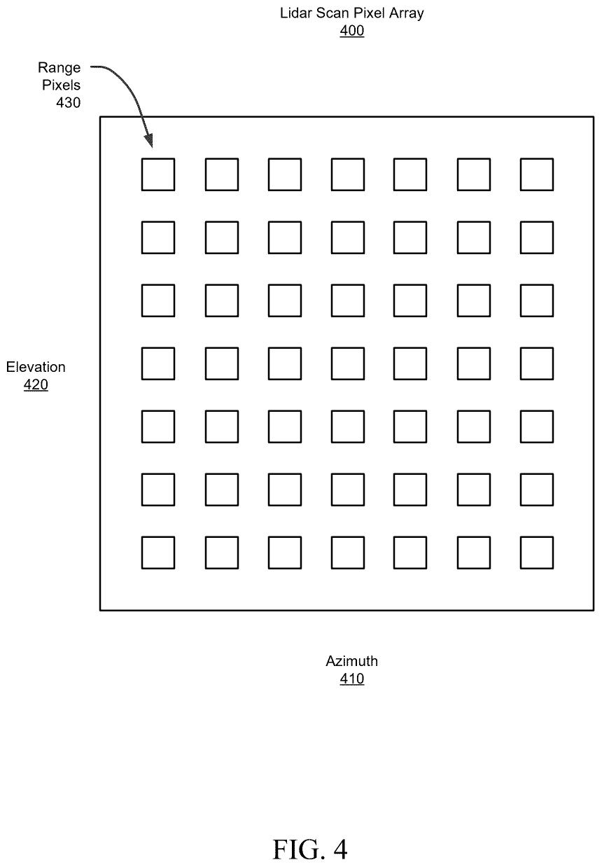

An example lidar scan point cloud represented by a pixel array 400 is shown in FIG. 4. Each pixel 430 of the array 400 is generated from a reflected pulse received from a particular direction (e.g., azimuth 410 and elevation 420) at a given time during the scan pattern. Each pixel 430 provides the range data to an object at that direction generating a point cloud.

The hazard detector 340 is configured to determine that at least one of the one or more objects is located within the scan area 250 based on an analysis of the array of pixels. For example, if a pixel indicates a pulse reflection within the scan area 250 at a range associated with the radiation hazard zone 140 then a determination is made that a hazard exists.

The radiation transmitter controller 360 is configured to disable the radiation transmitter of the aircraft based on the determination that a hazard exists, for example that at least one of the one or more objects is located within the scan area at a range that poses a potential danger. In some embodiments, the radiation transmitter controller 360 is configured to send a control signal 240 to the radiation transmitter 120 to cause the transmitter to cease transmitting the RF or laser radiation 210.

The false alarm mitigation processor 350 is configured to analyze the array of pixels 400 to determine that at least one of the one or more objects located within the scan area is a person. In some embodiments, the radiation transmission controller 360 is configured to disable the radiation transmitter 120 based on the determination that at least one of the one or more objects located within the scan area is a person, rather than just a determination of the presence of objects within the scan area, to reduce the hazard detection false alarm rate. In some embodiments, detection of a human based on analysis of the array of pixels may be performed using machine learning, template matching, or other suitable detection and identification techniques.

In some embodiments, rather than determining the presence of a human, the false alarm mitigation processor 350 may be configured to determine that one or more of the objects is moving based on comparison of pixel arrays 400 over a sequence of one or more scans. For example, a moving object will appear in different groups of pixels from a first scan at a first time to a second scan at a second time. This approach may be useful, for example, if the computational time required to recognize a human presence in the array of pixels is too great to provide radiation transmission lock out within a required time limit associated with a specified safety margin. This may depend on the processor speed, the choice of algorithms, and the power levels of the transmitted radiation (e.g., higher power radiation may require a faster lock out).

The aircraft state sensor 380 is configured to sense a state of the aircraft 110 hosting the radiation transmitter 120, where the state may indicate, for example, whether the aircraft is on the ground and stationary, on the ground and in motion, or in flight. In some embodiments, the state sensor may sense weight on the wheels of the aircraft to determine whether the aircraft is on the ground or in flight. In some embodiments, the state sensor may include inertial, navigational, or global positioning system (GPS) sensors to determine the position and state of motion of the aircraft.

The protection override controller 370 is configured to disable the radiation hazard protection system 130 in response to a determination that the aircraft 110 is in motion, for example based on the aircraft state sensor. This is done to prevent the radiation hazard protection system 130 from interfering with aircraft mission operations that may include radiation transmission.

FIG. 4 illustrate a lidar scan pixel array 400, in accordance with certain embodiments of the present disclosure. As previously described, each pixel 430 of the array 400 is generated from a reflected pulse received from a particular direction (e.g., azimuth 410 and elevation 420) at a given time during the scan pattern. For example, azimuth 410 may be associated with a left-to-right sweep of the scan and elevation may be associated with an up-down sweep of the scan, although this will vary with different scan angles and geometries. Each pixel 430 provides the measured range to an object at that direction.

### Methodology

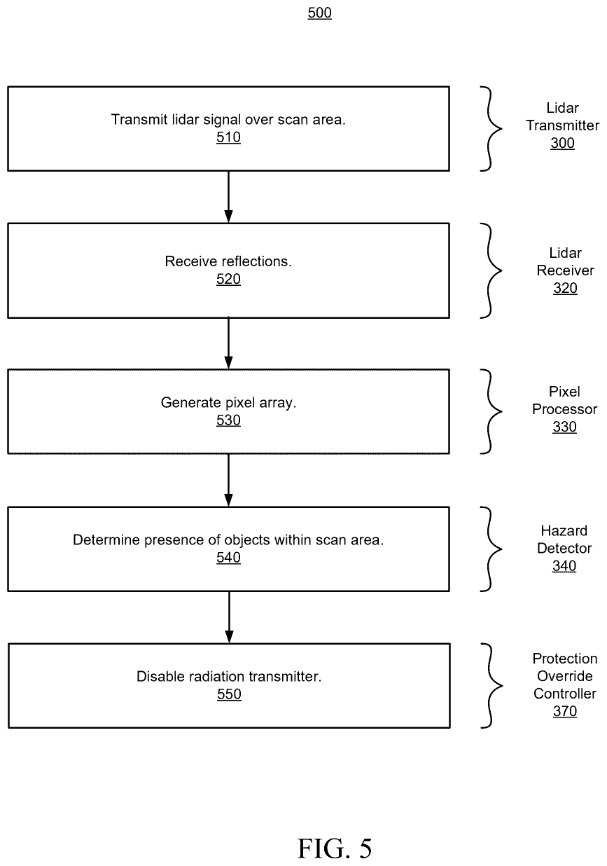

FIG. 5 is a flowchart illustrating a methodology 500 for providing radiation hazard protection, in accordance with an embodiment of the present disclosure. As can be seen, example method 500 includes a number of phases and sub-processes, the sequence of which may vary from one embodiment to another. However, when considered in aggregate, these phases and sub-processes form a process for operation of the radiation hazard protection system 130, in accordance with certain of the embodiments disclosed herein, for example as illustrated in FIGS. 1-4, as described above. However other system architectures can be used in other embodiments, as will be apparent in light of this disclosure. To this end, the correlation of the various functions shown in FIG. 5 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 500 commences, at operation 510, by controlling a lidar transmitter to transmit a lidar signal over a scan area. In some embodiments, the scan area is based on a volumetric region over which radiation propagates from the radiation transmitter of an aircraft. In some embodiments, the radiation source is a laser beam or a radio frequency transmission.

At operation 520, a lidar receiver is employed to receive reflections of the transmitted lidar signal from one or more objects within the scan area.

At operation 530, an array of pixels is generated based on the received reflections. For example, each of the pixels is mapped to one of the received reflections. The pixels provide a range from the lidar transmitter to a point on one of the one or more objects, such that the pixel array represents a point cloud.

At operation 540, an analysis of the array of pixels allows for a determination to be made that at least one of the one or more objects is located within the scan area. The analysis may also include determining that at least one of the one or more objects located within the scan area is a person, to reduce false alarms.

At operation 550, in response to the determination that at least one of the one or more objects is located within the scan area, the radiation transmitter (e.g., the RF and/or laser system of the aircraft) may be disabled.

In some embodiments, additional operations may be performed, as previously described in connection with the system. For example, the array of pixels may be analyzed to determine that at least one of the one or more objects located within the scan area is a person. The radiation transmitter may then be disabled based on the determination that a person is in the scan area.

In some embodiments, the method further comprises sensing a state of the aircraft hosting the radiation transmitter and ceasing to disable the radiation transmitter in response to a determination that the state of the aircraft indicates that the aircraft is in motion.

### Example System

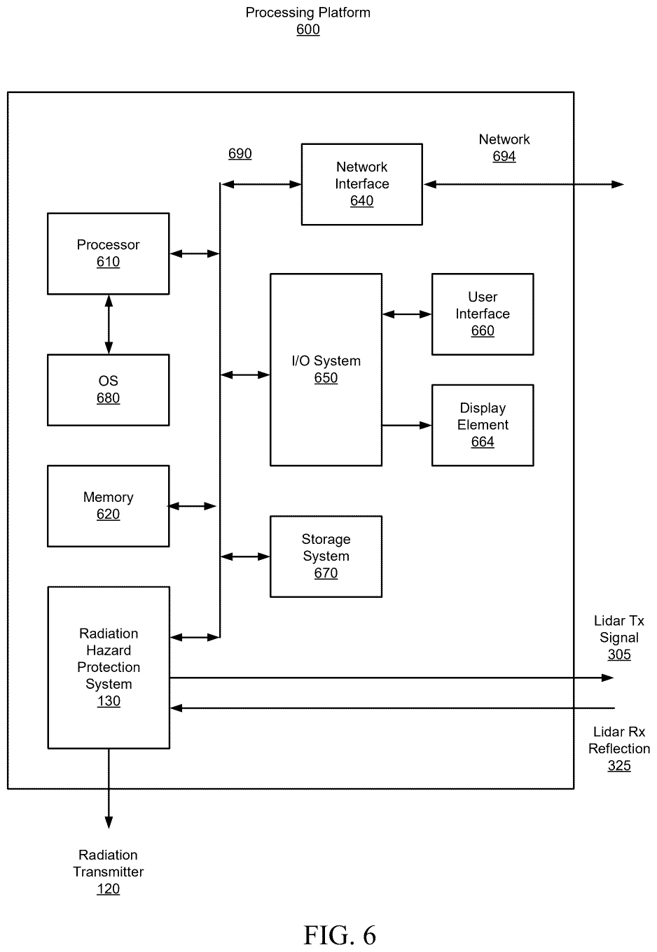

FIG. 6 is a block diagram of a processing platform 600 configured to provide radiation hazard protection, in accordance with an embodiment of the present disclosure. In some embodiments, platform 600, or portions thereof, may be hosted on, or otherwise be incorporated into the electronic systems of an aircraft.

In some embodiments, platform 600 may comprise any combination of a processor 610, memory 620, a network interface 640, an input/output (I/O) system 650, a user interface 660, a display element 664, a storage system 670, and radiation hazard protection system 130. As can be further seen, a bus and/or interconnect 690 is also provided to allow for communication between the various components listed above and/or other components not shown. Platform 600 can be coupled to a network 694 through network interface 640 to allow for communications with other computing devices, platforms, devices to be controlled, or other resources. Other componentry and functionality not reflected in the block diagram of FIG. 6 will be apparent in light of this disclosure, and it will be appreciated that other embodiments are not limited to any particular hardware configuration.

Processor 610 can be any suitable processor, and may include one or more coprocessors or controllers, such as an audio processor, a graphics processing unit, or hardware accelerator, to assist in the execution of mission software and/or any control and processing operations associated with platform 600, including operation of the radiation hazard protection system 130. In some embodiments, the processor 610 may be implemented as any number of processor cores. The processor (or processor cores) may be any type of processor, such as, for example, a micro-processor, an embedded processor, a digital signal processor (DSP), a graphics processor (GPU), a tensor processing unit (TPU), a network processor, a field programmable gate array or other device configured to execute code. The processors may be multithreaded cores in that they may include more than one hardware thread context (or “logical processor”) per core. Processor 610 may be implemented as a complex instruction set computer (CISC) or a reduced instruction set computer (RISC) processor. In some embodiments, processor 610 may be configured as an x86 instruction set compatible processor.

Memory 620 can be implemented using any suitable type of digital storage including, for example, flash memory and/or random access memory (RAM). In some embodiments, the memory 620 may include various layers of memory hierarchy and/or memory caches as are known to those of skill in the art. Memory 620 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 610 may be configured to execute an Operating System (OS) 680 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with platform 600, and therefore may also be implemented using any suitable existing or subsequently-developed platform.

Network interface 640 can be any appropriate network chip or chipset which allows for wired and/or wireless connection between other components of platform 600 and/or network 694, thereby enabling platform 600 to communicate with other local and/or remote computing systems, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution) and 5G, Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of platform 600. I/O devices may include, but not be limited to, user interface 660 and display element 664. User interface 660 may include devices (not shown) such as a touchpad, cockpit display unit, keyboard, and mouse, etc., for example, to allow the user to control the system. Display element 664 may be configured to display information to a user. I/O system 650 may include a graphics subsystem configured to perform processing of images for rendering on the display element 664. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 610 or any chipset of platform 600.

It will be appreciated that in some embodiments, the various components of platform 600 may be combined or integrated in a system-on-a-chip (SoC) architecture. In some embodiments, the components may be hardware components, firmware components, software components or any suitable combination of hardware, firmware, or software.

Radiation hazard protection system 130 is configured to disable high power RF or laser transmissions from an aircraft when human personnel are detected within a zone where such transmission would be hazardous, as described previously. Radiation hazard protection system 130 may include any or all of the circuits/components illustrated in FIGS. 1-4, as described above. These components can be implemented or otherwise used in conjunction with a variety of suitable software and/or hardware that is coupled to or that otherwise forms a part of platform 600. These components can additionally or alternatively be implemented or otherwise used in conjunction with user I/O devices that are capable of providing information to, and receiving information and commands from, a user.

In various embodiments, platform 600 may be implemented as a wireless system, a wired system, or a combination of both. When implemented as a wireless system, platform 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, platform 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired response time, computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), assembly instruction code, or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### FURTHER EXAMPLE EMBODIMENTS

The following examples pertain to further embodiments, from which numerous permutations and configurations will be apparent.

Example 1 is a radiation hazard protection system comprising: a light detection and ranging (lidar) transmitter configured to transmit a lidar signal over a scan area; a lidar receiver configured to receive reflections of the transmitted lidar signal from one or more objects within the scan area; a pixel processor configured to generate an array of pixels, each of the pixels mapped to one of the received reflections and providing a range from the lidar transmitter to a point on one of the one or more objects; a hazard detector configured to determine that at least one of the one or more objects is located within the scan area based on an analysis of the array of pixels; a radiation transmission controller configured to disable a radiation transmitter based on the determination; and a scan controller configured to select the scan area based on a volumetric region over which radiation propagates from the radiation transmitter.

Example 2 includes the system of Example 1, wherein the radiation is a laser beam transmission.

Example 3 includes the system of Examples 1 or 2, wherein the radiation is a radio frequency transmission.

Example 4 includes the system of any of Examples 1-3, comprising a false alarm mitigation processor configured to analyze the array of pixels to determine that at least one of the one or more objects located within the scan area is a person.

Example 5 includes the system of Example 4, comprising a radiation transmission controller configured to disable a radiation transmitter based on the determination that at least one of the one or more objects located within the scan area is a person.

Example 6 includes the system of any of Examples 1-5, comprising an aircraft state sensor configured to detect a state of motion of an aircraft hosting a radiation transmitter.

Example 7 includes the system of Example 6, comprising a protection override controller configured to disable the radiation hazard protection system in response to a determination that the aircraft state sensor detects that the aircraft is in motion.

Example 8 is a computer program product including one or more non-transitory machine-readable mediums encoded with instructions that when executed by one or more processors cause a process to be carried out for radiation hazard protection, the process comprising: controlling a light detection and ranging (lidar) transmitter to transmit a lidar signal over a scan area; controlling a lidar receiver to receive reflections of the transmitted lidar signal from one or more objects within the scan area; generating an array of pixels, each of the pixels mapped to one of the received reflections and providing a range from the lidar transmitter to a point on one of the one or more objects; determining that at least one of the one or more objects is located within the scan area based on an analysis of the array of pixels; disabling a radiation transmitter based on the determination; and selecting the scan area based on a volumetric region over which radiation propagates from the radiation transmitter.

Example 9 includes the computer program product of Example 8, wherein the radiation is a laser beam transmission.

Example 10 includes the computer program product of Examples 8 or 9, wherein the radiation is a radio frequency transmission.

Example 11 includes the computer program product of any of Examples 8-10, wherein the process comprises analyzing the array of pixels to determine that at least one of the one or more objects located within the scan area is a person.

Example 12 includes the computer program product of Example 11, wherein the process comprises disabling a radiation transmitter based on the determination that at least one of the one or more objects located within the scan area is a person.

Example 13 includes the computer program product of any of Examples 8-12, wherein the process comprises sensing a state of an aircraft hosting a radiation transmitter and suspending the process in response to a determination that the state of the aircraft indicates that the aircraft is in motion.

Example 14 is a method for providing radiation hazard protection, the method comprising: controlling a light detection and ranging (lidar) transmitter to transmit a lidar signal over a scan area; controlling a lidar receiver to receive reflections of the transmitted lidar signal from one or more objects within the scan area; generating an array of pixels, each of the pixels mapped to one of the received reflections and providing a range from the lidar transmitter to a point on one of the one or more objects; determining that at least one of the one or more objects is located within the scan area based on an analysis of the array of pixels; disabling a radiation transmitter based on the determination; and selecting the scan area based on a volumetric region over which radiation propagates from the radiation transmitter.

Example 15 includes the method of Example 14, wherein the radiation is a laser beam transmission.

Example 16 includes the method of Examples 14 or 15, wherein the radiation is a radio frequency transmission.

Example 17 includes the method of any of Examples 14-16, comprising analyzing the array of pixels to determine that at least one of the one or more objects located within the scan area is a person.

Example 18 includes the method of Example 17, comprising disabling a radiation transmitter based on the determination that at least one of the one or more objects located within the scan area is a person.

Example 19 includes the method of any of Examples 14-18, comprising detecting a state of motion of an aircraft hosting a radiation transmitter.

Example 20 includes the method of Example 19, comprising ceasing to disable the radiation transmitter in response to a determination that the aircraft is in motion.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A radiation hazard protection system comprising:
a light detection and ranging (lidar) transmitter configured to transmit a lidar signal over a scan area;
a lidar receiver configured to receive reflections of the transmitted lidar signal from one or more objects within the scan area;
a pixel processor configured to generate an array of pixels, each of the pixels mapped to one of the received reflections and providing a range from the lidar transmitter to a point on one of the one or more objects;
a hazard detector configured to determine that at least one of the one or more objects is located within the scan area based on an analysis of the array of pixels;
a radiation transmission controller configured to disable a radiation transmitter based on the determination; and
a scan controller configured to select the scan area based on a volumetric region over which radiation propagates from the radiation transmitter.

2. The system of claim 1, wherein the radiation is a laser beam transmission.

3. The system of claim 1, wherein the radiation is a radio frequency transmission.

4. The system of claim 1, comprising a false alarm mitigation processor configured to analyze the array of pixels to determine that at least one of the one or more objects located within the scan area is a person.

5. The system of claim 4, comprising a radiation transmission controller configured to disable a radiation transmitter based on the determination that at least one of the one or more objects located within the scan area is a person.

6. The system of claim 1, comprising an aircraft state sensor configured to detect a state of motion of an aircraft hosting a radiation transmitter.

7. The system of claim 6, comprising a protection override controller configured to disable the radiation hazard protection system in response to a determination that the aircraft state sensor detects that the aircraft is in motion.

8. A computer program product including one or more non-transitory machine-readable mediums encoded with instructions that when executed by one or more processors cause a process to be carried out for radiation hazard protection, the process comprising:
controlling a light detection and ranging (lidar) transmitter to transmit a lidar signal over a scan area;
controlling a lidar receiver to receive reflections of the transmitted lidar signal from one or more objects within the scan area;
generating an array of pixels, each of the pixels mapped to one of the received reflections and providing a range from the lidar transmitter to a point on one of the one or more objects;
determining that at least one of the one or more objects is located within the scan area based on an analysis of the array of pixels;
disabling a radiation transmitter based on the determination; and
selecting the scan area based on a volumetric region over which radiation propagates from the radiation transmitter.

9. The computer program product of claim 8, wherein the radiation is a laser beam transmission.

10. The computer program product of claim 8, wherein the radiation is a radio frequency transmission.

11. The computer program product of claim 8, wherein the process comprises analyzing the array of pixels to determine that at least one of the one or more objects located within the scan area is a person.

12. The computer program product of claim 11, wherein the process comprises disabling a radiation transmitter based on the determination that at least one of the one or more objects located within the scan area is a person.

13. The computer program product of claim 8, wherein the process comprises sensing a state of an aircraft hosting a radiation transmitter and suspending the process in response to a determination that the state of the aircraft indicates that the aircraft is in motion.

14. A method for providing radiation hazard protection, the method comprising:
controlling a light detection and ranging (lidar) transmitter to transmit a lidar signal over a scan area;
controlling a lidar receiver to receive reflections of the transmitted lidar signal from one or more objects within the scan area;
generating an array of pixels, each of the pixels mapped to one of the received reflections and providing a range from the lidar transmitter to a point on one of the one or more objects;
determining that at least one of the one or more objects is located within the scan area based on an analysis of the array of pixels;
disabling a radiation transmitter based on the determination; and
selecting the scan area based on a volumetric region over which radiation propagates from the radiation transmitter.

15. The method of claim 14, wherein the radiation is a laser beam transmission.

16. The method of claim 14, wherein the radiation is a radio frequency transmission.

17. The method of claim 14, comprising analyzing the array of pixels to determine that at least one of the one or more objects located within the scan area is a person.

18. The method of claim 17, comprising disabling a radiation transmitter based on the determination that at least one of the one or more objects located within the scan area is a person.

19. The method of claim 14, comprising detecting a state of motion of an aircraft hosting a radiation transmitter.

20. The method of claim 19, comprising ceasing to disable the radiation transmitter in response to a determination that the aircraft is in motion.
